(19) United States
(12) Patent Application Publication
(10) Pub. No.: US 2025/0164299 A1
(43) Pub. Date: May 22, 2025

(54) ACOUSTIC TRANSIT-TIME FLOWMETER

(71) Applicant: Titan Enterprises Ltd, Sherborne, Dorset (GB)

(72) Inventor: John Trevor Forster, Sherborne, Dorset (GB)

(21) Appl. No.: 18/839,602

(22) PCT Filed: Feb. 20, 2023
(86) PCT No.: PCT/EP2023/054241

§ 371 Date: Aug. 19, 2024

(30) Foreign Application Priority Data
Feb. 21, 2022 (GB) 2202309.7

(51) Int. Cl. G01F 1/667; G01F 1/66; G01F 15/14

(52) U.S. Cl. CPC G01F 1/667; G01F 1/662; G01F 15/14

(57) ABSTRACT

In some examples, a transit-time-differential acoustic flowmeter structure comprises a housing comprising a first part and a second part, the first part and the second part being releasably connectable to one another, wherein at least one of the first part and the second part define a channel portion to receive a disposable flow tube, wherein the first part of the housing comprising a first pair of transducers provided in spaced relation to one another.

### FIELD

The present disclosure relates, in general, to flowmeters. Aspects relate to flowmeter structures configured for use with disposable flow tubes.

### BACKGROUND

Many industrial, pharmaceutical and medical applications utilise flow meters to measure the rate of a fluid of a fluid flowing in a flow tube to enable, e.g., a determination to be made of the amount of that fluid to be dispensed, administered or used. Such flow meters can be sterilised and/or recalibrated and reused, or sometimes are provided as single use items that are discarded when a desired measurement cycle is completed. Typically, a flow meter will be calibrated in order to enable accurate measurements to be generated in a given situation. Discarding a calibrated flow meter, along with its calibration data, is an expensive option. Sterilising is time consuming and expensive, as is producing a device that is capable of being sterilised.

### SUMMARY

An objective of the present disclosure is to provide a reusable flowmeter apparatus that does not require calibration and/or sterilisation between measurement cycles.

The foregoing and other objectives are achieved by the features of the independent claims.

Further implementation forms are apparent from the dependent claims, the description and the Figures.

A first aspect of the present disclosure provides a transit-time-differential acoustic flowmeter structure, comprising a housing comprising a first part and a second part, the first part and the second part being releasably connectable to one another, wherein at least one of the first part and the second part define a channel portion to receive a disposable flow tube, wherein the first part of the housing comprising a first pair of transducers provided in spaced relation to one another.

In an implementation of the first aspect, each one of the first pair of transducers can form part of the channel portion for the first part of the housing. The second part of the housing can comprise a second pair of transducers provided in spaced relation to one another. Each one of the second pair of transducers can form part of the channel portion for the second part of the housing. The second pair of transducers can be aligned with the first pair of transducers such that, when the first part of the housing and the second part of the housing are connected to one another, respective ones of the first pair of transducers are adjacent to corresponding respective ones of the second pair of transducers, whereby to form a pair of annular transducer elements, or broken annular transducer elements (i.e., in the form of a pair of semi-circular transducer elements that comprise a pair of gaps between them when the first and second parts of the housing are brought together), for the flowmeter structure.

In an example, each one of the first pair of transducers can sit proud of a surface of the first part of the housing. For example, one or each transducer can sit slightly proud of a surface of a part of the housing and/or have a bore that is slightly smaller than that of a flow tube outside diameter, whereby to provide some flow tube compression when the first and second parts are brought together with a flow tube in situ in a channel portion. This can be similarly the case with transducers of the second part. Each one of the second pair of transducers can sit proud of a surface of the second part of the housing. For example, one or each transducer of the second part can sit slightly proud of a surface of that part of the housing and/or have a bore that is slightly smaller than that of a flow tube outside diameter.

In an example, the first part of the housing and the second part of the housing can be hingedly connected to one other. One or more hinges between the parts may be used. The first pair of transducers can be provided in respective recesses provided in the first part of the housing. The second pair of transducers can be provided in respective recesses provided in the second part of the housing. That is, a transducer can be effectively embedded into a part of the housing. A recess may be so profiled as to match the outer profile of a transducer and/or can comprise lugs or similar protrusions arranged to grip a transducer when in place in a recess. The first pair of transducers can be provided in respective recesses provided in the first part of the housing by way of interference fit and/or using an adhesive. The second pair of transducers can be provided in respective recesses provided in the second part of the housing by way of interference fit and/or using an adhesive. The channel portion can comprise a recess to receive a locating portion of a flow tube. Such a recess can comprise an opening in a part of the housing, or a cavity therein.

A second aspect of the present disclosure provides a flow tube for a transit-time-differential acoustic flowmeter structure as provided according to the first aspect.

A third aspect of the present disclosure provides a flow tube when used in a transit-time-differential acoustic flowmeter structure as provided according to the first aspect.

In an implementation of the second or third aspect, the flow tube can comprise a locating portion configured to engage with a recess provided in the channel portion. The locating portion can comprise at least one collar or sleeve provided on an outer surface of part of the flow tube. The at least one collar or sleeve can be an integral part of the flow tube.

In an implementation of the second or third aspect, the flow tube can comprise a locating portion configured to abut an outside surface of the first part or the second part of the housing. The locating portion can comprise a pair of collar or sleeves configured to abut opposing outside surfaces of the first part or the second part of the housing.

A fourth aspect of the present disclosure provides a transit-time-differential acoustic flowmeter, comprising a housing comprising a first part and a second part, the first part and the second part being releasably connectable to one another, wherein at least one of the first part and the second part define a channel portion to receive a disposable flow tube, wherein the first part of the housing comprising a first pair of transducers provided in spaced relation to one another, and a flow tube configured to releasably seat in the channel portion when the first part of the housing and the second part of the housing are connected together.

### BRIEF DESCRIPTION OF THE DRAWINGS

For a more complete understanding of the present disclosure, reference is now made, by way of example only, to the following descriptions taken in conjunction with the accompanying drawings, in which:

FIG. 1 is a schematic representation of a flow meter body according to an example, showing a pair of hingedly connected leave or portions, comprising a single pair of crystals (ultrasonic transducers) in one portion of the flow meter along with various styles of flow tubes;

FIG. 2 is a schematic representation of a flow meter body according to an example, in which three transducers are provided showing the possible differing flight lengths;

FIG. 3 is a schematic representation of a flow meter body according to an example, in which three transducers are provided in each portion of the flow meter (such that there are 3×2 sets of crystals);

FIG. 4 is a schematic representation of a side view of a flow meter body according to an example, in which the first part and the second part are closed together with a channel portion and transducers visible; and

FIG. 5 is a schematic representation of a flow meter body according to an example, in which protrusions and alignment portions are depicted.

### DESCRIPTION

Example embodiments are described below in sufficient detail to enable those of ordinary skill in the art to embody and implement the systems and processes herein described. It is important to understand that embodiments can be provided in many alternate forms and should not be construed as limited to the examples set forth herein. Accordingly, while embodiments can be modified in various ways and take on various alternative forms, specific embodiments thereof are shown in the drawings and described in detail below as examples. There is no intent to limit to the particular forms disclosed. On the contrary, all modifications, equivalents, and alternatives falling within the scope of the appended claims should be included. Elements of the example embodiments are consistently denoted by the same reference numerals throughout the drawings and detailed description where appropriate.

The terminology used herein to describe embodiments is not intended to limit the scope. The articles “a,” “an,” and “the” are singular in that they have a single referent, however the use of the singular form in the present document should not preclude the presence of more than one referent. In other words, elements referred to in the singular can number one or more, unless the context clearly indicates otherwise. It will be further understood that the terms “comprises,” “comprising,” “includes,” and/or “including,” when used herein, specify the presence of stated features, items, steps, operations, elements, and/or components, but do not preclude the presence or addition of one or more other features, items, steps, operations, elements, components, and/or groups thereof.

According to an example, there is provided a transit-time-differential acoustic flowmeter structure. The flowmeter structure comprises transducers for coupling to a replaceable flow tube. A fluid, whose rate of flow is to be measured, can pass through the flow tube, which can be replaced whilst retaining calibration of a flow meter external to the fluid path. That is, a calibrated flow meter is provided that can measure the rate of flow of a liquid or gas within a replaceable flow tube, pipe or conduit. When a measurement cycle is completed, a flow tube can be removed from the flowmeter and replaced, such that the flow meter can be reused without the need for sterilisation and/or recalibration and without the meter needing to be discarded.

A meter according to an example has a calibrated element which ensures that changes in the fluid conduit do not move the calibration data outside acceptable limits. Tests have shown that a ±5% shift with subsequent tube changes is easily possible and calculations suggest that a ±2% maximum shift in calibration should be achievable in production. Accordingly, a flow tube, or a portion of a flow tube, can be replaced as desired without the need for the flow meter to be recalibrated.

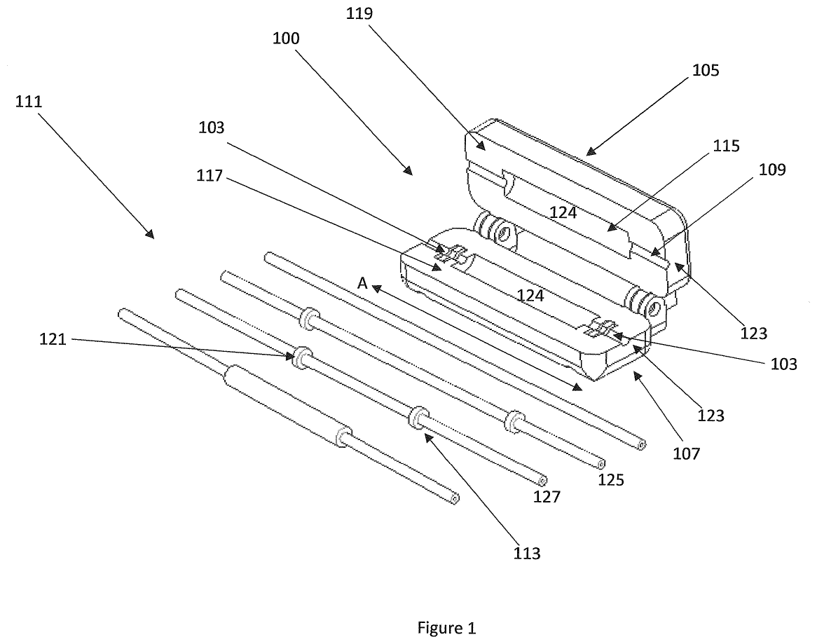

FIG. 1 is a schematic representation of a transit-time-differential acoustic flowmeter structure according to an example. A flow meter structure according to an example comprises a clamp-on flow meter 100 that comprises at least two ultrasonic crystals (transducers) 103 mounted in spaced relation from another a fixed distance apart in suitable a housing or body structure. Exemplary body structures for a flow meter are shown in the accompanying drawings. In an example, the flow meter comprises an opposing pair of hingedly connected parts or portions 105, 107 so configured as to receive a portion of a flow tube. The hinged portions can be closed together thus securing or capturing the flow tube between the portions. Portions need not be hingedly connected, and may be separate, in which case they may be configured to releasably clip together. In an implementation, closing together of parts 105, 107 does not present any constriction of a flow tube. A flow tube can be held in place within a channel portion defined between the parts 105, 107 by way of transducers, as will be described below in more detail.

In the example of FIG. 1, the transit-time-differential acoustic flowmeter structure 100 comprises a housing comprising a first part 107 and a second part 105, the first part 107 and the second part 105 being releasably connectable to one another. At least one of the first part 107 and the second part 105 define a channel portion 109 to receive a disposable flow tube. In an implementation, the first part 107 of the housing comprises a first pair of transducers 103 provided in spaced relation to one another.

In an example, the channel portion 109 extends through/across at least one of the first part 107 and the second part 105, as depicted. The channel portion can be defined by both of the first part 107 and the second part 105, as depicted in FIG. 1 for example, in which each of the first part 107 and the second part 105 comprise, e.g., a semi-circular recess, each defining—in the example of FIG. 1—one half (or other suitable fractional portion, e.g., ⅓ and ⅔) of the channel portion. That is, when the first part 107 and the second part 105 are brought together, the recessed portions come together to define the channel portion, which in the instant example would be of circular cross-section. The cross-sectional shape or profile of a channel portion can be circular. A flow tube can have a corresponding circular cross-section. Other cross-sectional shapes or profiles can be used, as will be appreciated. A channel portion can have a diameter in the region of around 1-10 mm for example. A flow tube can have a corresponding diameter that matches the diameter of the channel portion of the flow meter structure it is to be used with and for which the structure has been calibrated. That is, in an example, a flow meter apparatus can be physically dimensioned (e.g., a channel portion can be dimensioned and the relative disposition of transducers can be provided and calibrated) to correspond to the physical dimensions of a flow tube, or vice versa, such that the apparatus can be repeatably used with flow tubes that match those parameters for which the apparatus has been commissioned (e.g., dimensioned and calibrated for use with). Accordingly, use of other flow tubes with the same physical parameters (e.g., inner and outer diameters, material and so on) will not affect the ability of the apparatus to accurately measure the rate of flow within a such a flow tube as the calibration will still be valid and relevant. Furthermore, repeated sterilisation of the apparatus need not be required as used flow tubes can be replaced with new/sterile ones for subsequent measurement cycles.

In an example, a flow tube or conduit is held in place by, e.g., frictional forces that prevent it from moving without restricting or altering the rate of flow of a liquid within the flow tube. A recess or channel portion 109 defined by the portions for receiving the flow tube may have a constant cross-section along its length. Alternatively, as shown in some of the figures for example, the portions may come into contact with the conduit only at regions in which ultrasonic transducers are provided, with somewhat larger regions or voids in between defined by, e.g., cavities or recesses formed by the first and second parts of the housing.

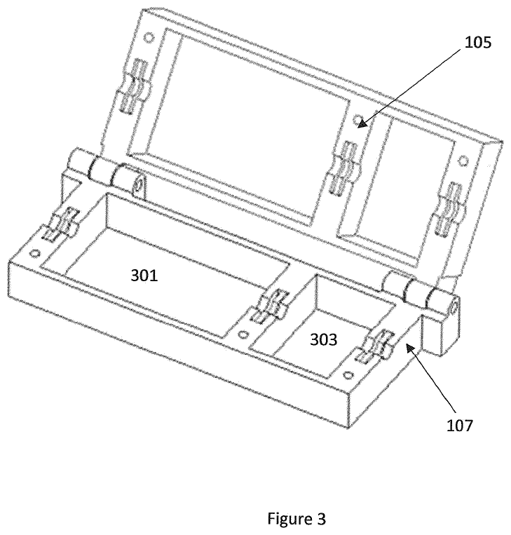

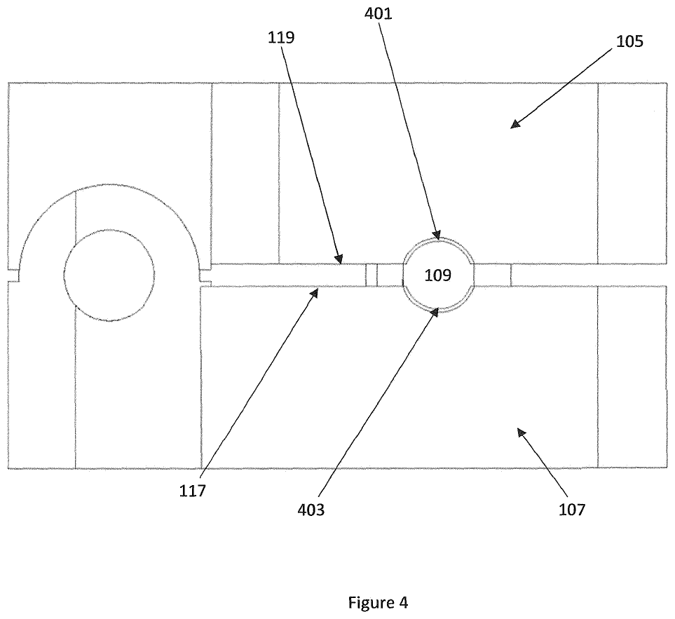

According to an example, pairs of transducers (e.g., piezoelectric crystals) in one part of the housing may or may not have an opposing pair in the other part of the housing (which can form, e.g., a closing cover for the structure). That is, each part (portion or leaf) of the housing of the flow meter structure may comprise a portion (such as one half) of a transducer (see FIG. 3 for example). Alternatively, transducers may be provided in only one part, portion or leaf of the housing of the flow meter, as shown in FIG. 1 for example. The inclusion of a second pair (i.e., transducers in both parts of the flow meter) can almost fully encircle the flow tube when the parts are brought together. For example, a pair of transducers in the first part of the housing can be aligned with a pair of transducers in the second part of the housing such that when the first part of the housing and the second part of the housing are connected to one another the transducers in each part of the housing form a pair of annular transducer elements for the flowmeter structure. In this particular example, each transducer will be semi-circular in cross-section, but other cross-sectional profiles can be used in order to provide a different shaped aperture that can receive a flow tube. In other implementations, a pair of transducers in the first part of the housing can be aligned with a pair of transducers in the second part of the housing such that when the first part of the housing and the second part of the housing are connected to one another the transducers in each part of the housing form a broken annulus (see, for example, FIG. 4).

In the example of FIG. 1, a first pair of transducers 103 are provided in the first part 107 of the housing. Each one of the first pair of transducers 103 can sit proud of a surface 117 of the first part 107 of the housing. The surface 117 includes the surface of the channel portion (the surface on the inside face of a part of the housing). Accordingly, in an example, each one of the first pair of transducers 103 can sit proud of the channel portion of the first part 107 of the housing. That is, for example, at a region of the channel portion at which a transducer is provided, the diameter of the channel portion is reduced. This can similarly be the case for a second pair of transducers provided in the second part 105 of the housing.

Accordingly, when the first and second parts are connected together, the provision of transducer pairs that sit proud of the surface 117 (and/or surface 119 in the case of the second pair of transducers if provided in the second part) has a clamping action on a flow tube. That is, at the region(s) at which as flow tube is in contact with a pair of transducers, the flow tube may be gripped, pinched, or constricted at those points between the transducers from the first and second parts, or between the transducers of one part and the channel portion of the other part. Since the flowmeter structure is calibrated for use with flow tubes of a selected diameter, any constriction as a result of a flow tube being gripped as described above is already ‘calibrated in’, and use with any flow tube of the selected diameter will not affect repeatably accurate measurements of flow rate of a liquid flowing through the flow tube. That is, in an example, transducers can sit slightly proud of a surface and/or have a bore that is slightly smaller than that of a flow tube outside diameter, whereby to provide some flow tube compression. With dedicated flow tubes such slight compression is part of the calibration. Such compression enables an acoustically stable, sound, unimpaired interface between a transducer and the flow tube.

At a given temperature range a mechanical assembly comprising a combination of the flow meter structure and a flow tube will be substantially stable. Accordingly, deviations in measurements of flow rate between such combinations in which flow tubes of a selected size are changed will be negligible. Electronic components, such as components used to drive transducers and/or receive and process measurements from transducers can be provided either locally (non-autoclave) or remotely from the structure.

According to an example, transducers can be provided in recessed portions of a part of the housing. Transducers can be fixed into such recesses by way of interference fit and/or using an adhesive. In some examples, a transducer can comprise an encapsulated crystal that can be provided in a recess. Such an encapsulated transducer can be wipeable or capable of being sterilised in an autoclave.

A flow tube 111 may be plain or have a means of locating the tube in a precise position within the body. For example, a locating portion in the form of, e.g., protuberances 113 on the surface of the flow tube may be provided to mate with correspondingly profiled recesses 115 within the flow meter body (or vice versa). In an example, a channel portion can therefore comprise a recess to receive a locating portion of a flow tube. A locating portion can be configured to engage with a recess provided in the channel portion. In an implementation, a locating portion can comprise at least one collar or sleeve 121 provided on an outer surface of part of a flow tube. The at least one collar or sleeve can be an integral part of the flow tube. In an example, a flow tube can comprise a locating portion 121 configured to abut an outside surface 123 of the first part or the second part of the housing. A locating portion can comprise a pair of collar or sleeves configured to abut opposing outside surfaces of the first part or the second part of the housing (as shown in FIG. 1 with flow tube 125 for example). In an example, a locating portion can comprise a pair of collar or sleeves configured to abut opposing inner surfaces of a recess 124 of the first part or the second part of the housing (as shown in FIG. 1 with flow tube 127 for example. Accordingly, a flow tube can comprise means for locating the flow tube within a channel portion of a housing, such as collars, lugs or flanges that locate the flow tube in fixed positions to ensure that the tube is not slightly stretched or compressed. This ensures there are no dimensional changes introduced with the flow tube insertion and thus no resulting calibration issues.

In an example, there is a means of latching the body to ensure an acoustic coupling between the crystals mounted within the body and the tube carrying the fluid. That is, the parts, portions or leaves of the housing of the flow meter can be secured together using a releasable mechanism that enables a flow tube therein to be accessed and replaced as required. Such a releasable mechanism can comprise a catch mechanism and/or a magnetic catch system for example (e.g., each part of the housing can comprise one or more magnets so arranged to attract magnets in the other part of the housing).

According to an example, the assembly is calibrated in such a way that a flow tube can be changed without a significant change in the flow meter's calibration.

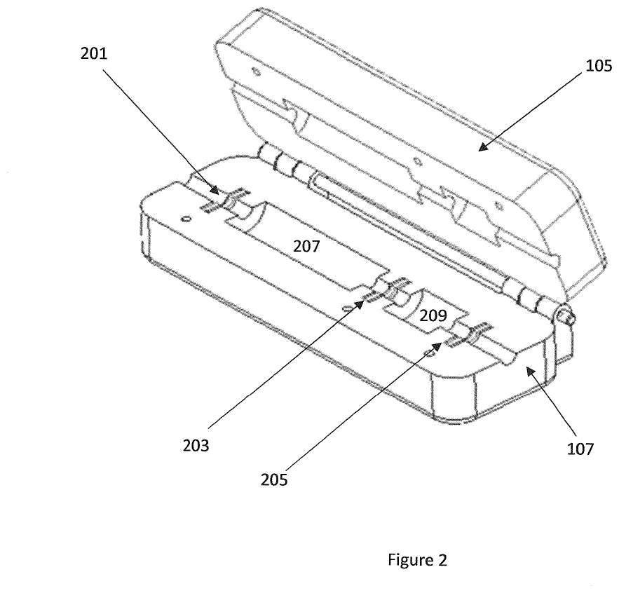

According to an example, with reference to FIGS. 2 and 3 for example, a third of set of crystals can be included, which, if mounted asymmetrically, such as, e.g., ⅓ along the length of the metering tube offers 3 possible flight lengths. In the example of FIG. 2, the three transducers are spaced irregularly from one another with respect to the long axis of the flow meter, although it will be appreciated that the spacing between the three transducers may be the same.

For example, in a flow meter comprising a first 201, second 203 and third 205 set of crystals (transducers) mounted asymmetrically along the length of the flow meter, there are three measurement lengths corresponding to the distance between crystals one to two, two to three and one to three. This increases the dynamic range of the meter. Associated electronics can then be used to select the most appropriate pair of crystal sets to take measurements. For example, with very low flows, the greatest distance between the crystals is automatically selected to ensure the largest possible phase shift and greatest accuracy. When the phase shift becomes too large at extremely high flows the shortest flow distance may be chosen. Using this method the electronic calculations are always optimised for the best signal to noise and phase shift characteristics. The meter may be configured where the exposed faces of the crystals may or may not be protected with a suitable interface. As can be seen in FIG. 2, two recessed portions 207, 209 can be provided, which can be used as described above, with reference to FIG. 1 for example, to locate a flow tube with one or more suitable corresponding locating portions, such as collars. One or both of the recesses 207, 209 can be used for this purpose.

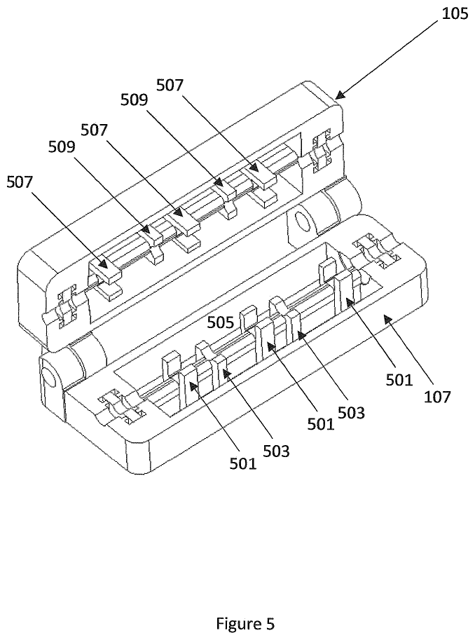

With reference to FIG. 3 and FIG. 5, it can be seen that a channel portion is defined by way portions of the first part and the second part of the housing and that the first part and the second part of the housing comprise significant regions that are devoid of any material, thus reducing weight and materials for example. In FIG. 3 for example, regions 301, 303 of the first part of the housing are devoid of material. Similar regions are provided in the second part of the housing of the structure of FIG. 3.

FIG. 4 is a schematic representation of a side view of a flow meter body according to an example, in which the first part and the second part are closed together with a channel portion 109 and transducers 401, 403 visible. As can be seen in FIG. 4, transducers 401, 403 sit proud of the surfaces 117, 119 of the first and second parts respectively. That is, a surface 117 defines an inner surface for part 107. The inner surface 117 defines a part of a surface of the channel portion 109. Transducer 403 sits proud of the surface 117, or has a bore that is slightly smaller than that of a flow tube outside diameter, whereby to provide some flow tube compression (for a flow tube situated in channel portion 109) when the parts are brought together. This is similarly the case for the surface 119 of part 105 and transducer 401. With dedicated flow tubes such slight compression is part of the calibration. Such compression enables an acoustically stable, sound, unimpaired interface between a transducer and the flow tube.

Referring to FIG. 5, the channel portion is defined by way of sets of protrusions 501 that are configured to receive and hold a flow tube at various locations along the length of the flow tube. Three such sets of protrusions 501 are depicted in the example of FIG. 5. The sets of protrusions can be evenly spaced within a void 505 or recessed portion of the first and/or second parts of the housing. Two sets of alignment protrusions 503 are provided in the example of FIG. 5 that can be used to maintain alignment of a flow tube in the housing and ensure that the flow tube is seated properly without bends, constrictions and so on. Alignment portions 503 can be provided in between sets of protrusions, as depicted in FIG. 5 for example. Similar sets of protrusions and/or alignment portions can be provided in a second part of the housing. In an example, with reference to FIG. 5, the sets of protrusions 507 in the second part can be offset with respect to the sets of protrusions 501 such that, when the parts are brought together, a flow tube is held in multiple positions along its length (six such positions in the example of FIG. 5) defined by the positions of the sets of protrusions 501, 507. Alignment portions 509 for the second part may be similarly offset from those (503) of the first part, or, in an example, as the alignment portions do not protrude as much as the sets 501, 507, they may be arranged in-line with one another because alignment portions of the first part and the second part will not interfere with one other when the parts are brought together in t same way that the sets 501, 507 would. That is, in an example, a set of alignment portions 503 can butt up against a set of alignment portions 509, which can provide an added degree of capture for a flow tube.

In the example of FIG. 5, transducers may be provided proud of or flush with corresponding surfaces of the parts. That is, in an implementation, since a flow tube is maintained in stable position within the structure using the protrusions (e.g., clip portions) 501, 507, no gripping of the flow tube may be needed by the transducers. The inner diameter of a semi-circular transducer can match the outer diameter of a (e.g., circular) flow tube, thereby enabling an acoustically stable, sound, unimpaired interface between a transducer and the flow tube.

According to an example, a transit-time-differential acoustic flowmeter structure comprises transducers as described above with reference to FIGS. 1 to 5. Such transducers, defining annular or part-annular (such as a broken annulus as depicted in FIG. 4 for example) elements induce a plane ultrasonic wave when excited. Such a plane wave travels with a wavefront parallel to a direction of fluid flow in a flow tube, i.e. substantially parallel to a long axis of a channel portion (such as parallel to direction A as depicted in FIG. 1 for example). Such a plane wave is not refracted by a flow tube (for example, an angular beam that travels diagonally across a flow tube would be). Furthermore, by developing a planar wavefront that travels along the flow tube, much lower velocity readings can be taken as the phase shift provided by such a system is relatively large. That is, for example, diagonal or perpendicular beams that travel across a flow tube will have with a very short time of flight through the fluid in a flow tube so much higher frequencies are required for a reasonable phase shift to be developed that enables a velocity measurement to be calculated. However, in the present apparatus, an induced plane wave travels along the tube and is therefore capable of much lower velocity readings as the phase shift is relatively large. This also means that the whole system can run at a lower processing speed, which means that the structure is relatively less expensive for lower flow rates. Accordingly, a plane wave induced by the structure as described herein has a long flight path, up to the order of around 50 times longer than existing systems. This results in a relatively bigger phase shift for a given frequency. As such, lower frequencies and reduced processing speed can be used to achieve the same level of phase shift as existing systems, and lower velocity readings are possible. There is also less attenuation to the signal strength as there is only a single tube crossing for each transmit/receive operation for transducers. Furthermore, an induced plane wave in the liquid in a flow tube is of a wavelength greater than the diameter of the flow tube and so no reflections are possible. In an example, acoustic gel may be used to provide an interface between a transducer and a flow tube. However, because of the physical design of the structure as described above and the afore-mentioned characteristics of the structure, acoustic gel is not needed.

### Advantages:-

1. One calibration for the meter with excellent repeatability between multiple tube changes.
2. The distance between the crystals is fixed so the time of flight will always remain with known parameters.
3. The flow tubes could be low-cost disposable items.
4. The clamping force can be arranged to be constant with repeated opening and closing to ensure consistent acoustic coupling.
5. Various material disposable flow tubes can be used.
6. The flow tubes can be configured with a variety of end fittings to suit user requirements.
7. The flow tubes can incorporate location or locating features to ensure correct positioning within the body.
8. Multiple flow ranges are possible if a multi sensor configuration is used.
9. Performance can be further improved with complimentary oscillators on both sides of the fluid conduit (as shown in FIG. 3 for example).
10. There is no need for further acoustic damping as the flow tube is continuous.
11. The tubes and oscillators may be any shape and cross section with appropriately shaped tubing to suite.

Unless otherwise defined, all terms (including technical and scientific terms) used herein are to be interpreted as is customary in the art. It will be further understood that terms in common usage should also be interpreted as is customary in the relevant art and not in an idealized or overly formal sense unless expressly so defined herein.

1. A transit-time-differential acoustic flowmeter structure, comprising: a housing comprising a first part and a second part, the first part and the second part being releasably connectable to one another, wherein at least one of the first part and the second part define a channel portion to receive a disposable flow tube, wherein the first part of the housing comprising a first pair of transducers provided in spaced relation to one another.

2. The transit-time-differential acoustic flowmeter structure as claimed in claim 1, wherein each one of the first pair of transducers forms part of the channel portion for the first part of the housing.

3. The transit-time-differential acoustic flowmeter structure as claimed in claim 1, wherein the second part of the housing comprises a second pair of transducers provided in spaced relation to one another.

4. The transit-time-differential acoustic flowmeter structure as claimed in claim 3, wherein each one of the second pair of transducers forms part of the channel portion for the second part of the housing.

5. The transit-time-differential acoustic flowmeter structure as claimed in claim 3, wherein the second pair of transducers are aligned with the first pair of transducers such that, when the first part of the housing and the second part of the housing are connected to one another, respective ones of the first pair of transducers are adjacent to corresponding respective ones of the second pair of transducers, whereby to form a pair of annular transducer elements for the flowmeter structure.

6. The transit-time-differential acoustic flowmeter structure as claimed in claim 1, wherein each one of the first pair of transducers sits proud of a surface of the first part of the housing.

7. The transit-time-differential acoustic flowmeter structure as claimed in claim 3, wherein each one of the second pair of transducers sits proud of a surface of the second part of the housing.

8. The transit-time-differential acoustic flowmeter structure as claimed in claim 1, wherein the first part of the housing and the second part of the housing are hingedly connected to one other.

9. The transit-time-differential acoustic flowmeter structure as claimed in claim 1, wherein the first pair of transducers are provided in respective recesses provided in the first part of the housing.

10. The transit-time-differential acoustic flowmeter structure as claimed in claim 3, wherein the second pair of transducers are provided in respective recesses provided in the second part of the housing.

11. The transit-time-differential acoustic flowmeter structure as claimed in claim 9, wherein the first pair of transducers are provided in respective recesses provided in the first part of the housing by way of interference fit and/or using an adhesive.

12. The transit-time-differential acoustic flowmeter structure as claimed in claim 10, wherein the second pair of transducers are provided in respective recesses provided in the second part of the housing by way of interference fit and/or using an adhesive.

13. The transit-time-differential acoustic flowmeter structure as claimed in claim 1, wherein the channel portion comprises a recess to receive a locating portion of a flow tube.

14. A flow tube for a transit-time-differential acoustic flowmeter structure as claimed in claim 1.

15. (canceled)

16. The flow tube as claimed in claim 14, wherein the flow tube comprises a locating portion configured to engage with a recess provided in the channel portion.

17. The flow tube as claimed in claim 15, wherein the locating portion comprises at least one collar or sleeve provided on an outer surface of part of the flow tube.

18. The flow tube as claimed in claim 16, wherein the at least one collar or sleeve is an integral part of the flow tube.

19. The flow tube as claimed in claim 14, wherein the flow tube comprises a locating portion configured to abut an outside surface of the first part or the second part of the housing.

20. The flow tube as claimed in claim 14, wherein the locating portion comprises a pair of collars or sleeves configured to abut opposing outside surfaces of the first part or the second part of the housing.

21. A transit-time-differential acoustic flowmeter, comprising:
a housing comprising a first part and a second part, the first part and the second part being releasably connectable to one another, wherein at least one of the first part and the second part define a channel portion to receive a disposable flow tube, wherein the first part of the housing comprising a first pair of transducers provided in spaced relation to one another; and
a flow tube configured to releasably seat in the channel portion when the first part of the housing and the second part of the housing are connected together.
